(19) United States
(12) Patent Application Publication
(10) Pub. No.: US 2010/0225115 A1
(43) Pub. Date: Sep. 9, 2010

(54) WAVE POWER STATION

(76) Inventor: Atanas Atanasov, Varna (BG)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/680,572

(22) PCT Filed: Oct. 10, 2008
(86) PCT No.: PCT/BG08/00018

§ 371 Date: Mar. 28, 2010

(30) Foreign Application Priority Data
Oct. 10, 2007 (BG) 109973

(51) Int. Cl. F03B 13/18

(52) U.S. Cl. 290/53

(57) ABSTRACT

The device is applied in energetics for receiving electrical energy from the sea waves. The wave power station consists of a generator, coupled to an energy-receiving shaft, comprised of a definite number of energy-receiving modules, joint in series to each other, fixed on a common platform and each energy-receiving module consists of a flywheel (10), mounted on a shaft (8) fixed via bearing bodies (6) to the platform, and a pulley (7), on which pulley a ratchet-wheel-gear (13) is mounted, engaged with a ratchet pawl (16), mounted to the platform, connected with the electric magnet (11). On the ratchet-wheel-gear (13) a ratchet pawl is mounted (15), engaged with a ratchet-wheel-gear (14), mounted on the shaft (08). On the pulley (07) a rope is wound, one end of which, via n-multiple polyspast (03), is connected to the operating float (02), situated in a protective chamber (01), whose entrance is expanded and directed towards the front of the waves, and the other end is connected to counterweight (05).

### SCOPE

The invention deals with receiving energy from the sea waves.

### HISTORY

A great number of devices for receiving energy from the sea waves are known. All of them (without exception) are intended to transform the waves' kinetic energy /1, 2, 3/. One of them is a device for receiving energy from the sea waves, consisting of a generator, coupled with an energy-receiving shaft, which consists of energy-receiving modules, joint to each other in series, situated at a certain distance from each other, fixed to a common platform and each energy-receiving module consists of a flywheel, mounted on a shaft fixed via bearing bodies to the platform, and a pulley is joined to the shaft via bearings, on which pulley a ratchet pawl is mounted, engaged with a ratchet-wheel-gear, mounted to the shaft, a rope is wound on the pulley, one end of the rope connected to an operating float and the other end—to a counterweight /1/.

Disadvantage of the devices known so far is that the energy received from the generator is adequate to the natural dynamics of the sea waves, low in potential and useless directly (without transformation).

### TECHNICAL ESSENCE OF THE INVENTION

The task for effective usage of the energy of the sea waves is solved with the wave power station, consisting of a generator, coupled to an energy-receiving shaft, comprised of a certain number of energy-receiving modules, connected to each other in series and situated at a definite distance from each other, fixed to a common platform; each module consists of a flywheel, mounted on a shaft, fixed via bearing bodies to the platform, to which shaft a pulley is joined via bearings and a ratchet pawl is mounted on the pulley, engaged with a ratchet-wheel-gear, mounted on the shaft of the module. On the pulley is mounted a ratchet-wheel-gear, engaged with a ratchet pawl, attached to the platform, connected to an electromagnet, and on the pulley a rope is wound, the one end of which, through n-multiple polyspast is connected to an operating float, situated in a protective chamber, and the other end is connected to a counterweight. The moment of operating of the electromagnet is determined by a logical control unit, which assesses the minimum level of the water in the protective chamber, the entrance of which is widened and facing the front of the waves.

An advantage of the invention is its idea, which is diametrically contrary to that of the devices known so far, i.e.: usage of the potential energy of the sea waves (lifting a float with a weight equal to the weight of the water displaced by it) in which way an energy is accumulated in an environment with a certain density (water), holding the float at the maximum reached level and releasing it when the minimum of the water level underneath is reached. In this way the receiving of the kinetic energy is done in an environment with a different density (air). The energy received efficiently is significantly (several times) greater than that resulting of the use of the known so far devices. In addition the use of a polyspast increases abruptly the kinetic energy received from the energy-receiving shaft and allows the use of a standard synchronic three-phase generator. The widening of the entrance of the protective chamber leads to a relative increase of the level of the water towards the maximum of the wave.

### EXPLANATION FOR THE ENCLOSED FIGURES

An exemplary implementation of the invention is shown on the enclosed figures, and:

FIG. 1 represents cross section of the energy-receiving shaft along one of the energy-receiving modules.

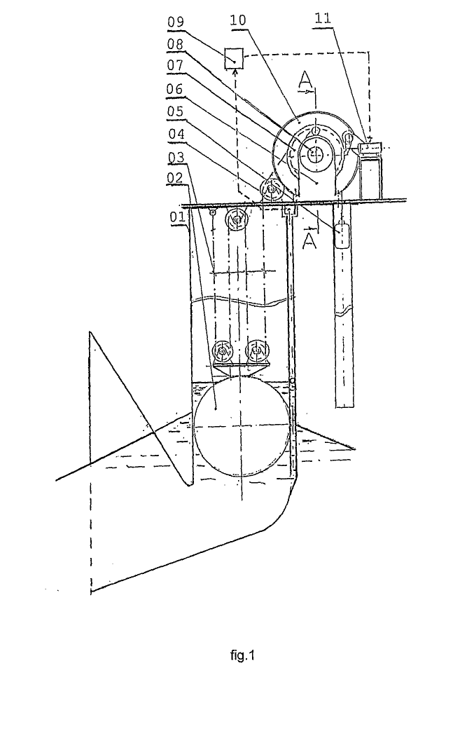

FIG. 2 represents longitudinal section of the energy-receiving shaft in the area of two neighbour energy-receiving modules.

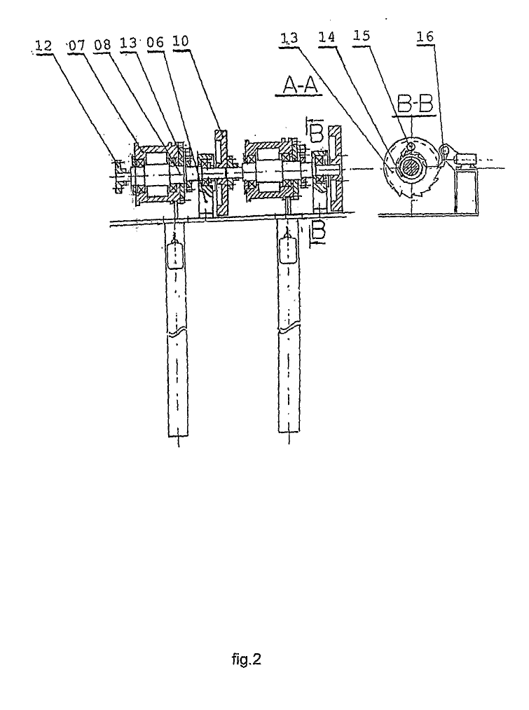

FIG. 3 represents a view from above of two energy-receiving modules.

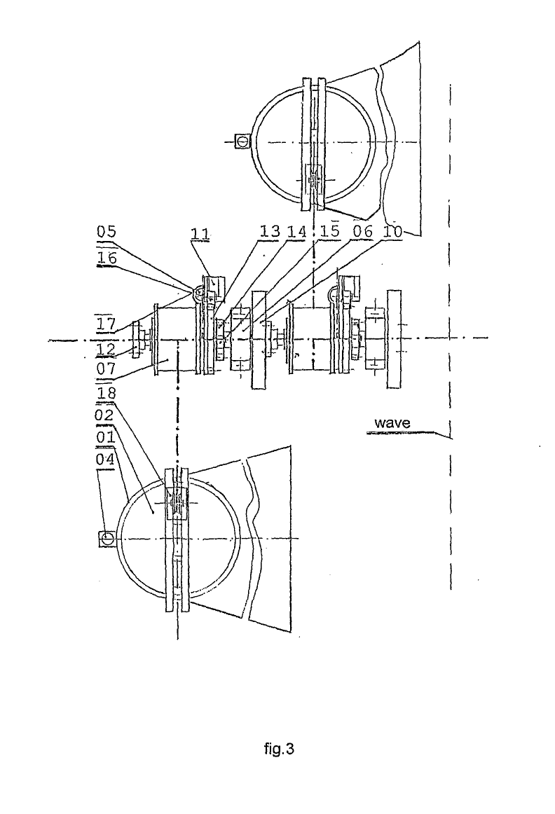

### EXAMPLE FOR IMPLEMENTATION OF THE INVENTION

The wave power station consists of a generator, comprising energy-receiving modules, joint to each other in series, situated at a certain distance from each other, fixed to a common platform and each energy-receiving module consists of a flywheel /10/, mounted on a shaft /8/ fixed via bearing bodies /6/ to the platform, and a pulley /7/ is joined to the shaft via bearings, on which pulley a ratchet pawl /15/ is mounted, engaged with a ratchet-wheel-gear /14/, mounted on the shaft of the module. On the pulley /07/ a ratchet-wheel-gear /13/, engaged with a ratchet pawl /16/, fixed to the platform, connected to an electromagnet /11/, on which pulley a rope is wound, one end of which, via n-multiple polyspast /03/, is connected to an operating float /2/, situated in a protective chamber /01/, and the other end is connected to a counterweight /05/. The moment of operating of the electromagnet /11/, releasing the suspended in the air operating float /02/, is determined by a logical control unit /09/, assessing the minimum level of the water in the protective chamber /01, whose entrance is widened and facing the front of the waves.

The wave power station works in the following way:

When the sea surface is calm, the operating floats of all modules are completely immersed in the water. The ropes connected to them are stretched tight in result of the action of the counterweights. The system is still and in balance. When a wave appears, the level of the water in the protective chamber of the first module rises. The operating float /02/ rises together with it. Under the effect of the counterweight, the pulley /07/ rotates and the rope winds through the polyspast. The two ratchet gears /13-16 and 14-15/ do not obstruct this movement. After reaching the maximum, the level starts to drop. The operating float /02/ seeks to come down, however the engaged ratchet pawl does not allow it and it remains suspended in the air. Then the wave reaches consecutively the remaining modules, which act in an analogical way. After reaching the minimum level of the water in the protective chamber /01/ of the first module, the logical control unit /09/ signals its electromagnet into operation /11/. It draws the ratchet pawl /16/ and keeps it in this position for a certain time. The operating float /02/ falls down as a free falling body. The rope unwinds through the polyspast from the pulley /07/ and rotates it. When the speed of rotation of the pulley /07/ equalizes with that of the energy-receiving shaft, the ratchet pawl /15/ engages the ratchet-wheel-gear /14/ and transmits the accumulated potential energy to the energy-receiving shaft (the generator). Meanwhile, the rope, connected to the counterweight /05/ winds itself on the pulley /07. When the operating float /02/ is immersed into the water, its speed decreases, respectively does the speed of the rope, unwinding from the pulley /07/ and the ratchet pawl /15/ disengages from the ratchet-wheel-gear /14/. The energy-receiving shaft continues to rotate under the action of the energy, accumulated in the flywheel /10/. Meanwhile, the level of the water in the protective chamber /01/ of the next module reaches the minimum level and its electromagnet /11/ receives a signal for operating from the logical control unit /09/. In this way the generator acquires a constant turning torque.

Application of the Invention

The wave power station may be built-up:

A. On the shore, using the energy of the surf waves.

B. On oil rigs.

C. On floating, anchored at appropriate places, energy-receiving platforms and energy-receiving parks.

### REFERENCE

1. M. McCormik “OCEAN WAVE CONVERSION”, New York, 1981

2. Eng., PhD Stefka Kanturska “The energy of sea waves is transformed into electricity”, “Marine world” magazine, February 2004

3. “ECOWATT TECHNOLOGIES”, www.b2b.bg

1. A wave power station comprising a generator, coupled with an energy-receiving shaft, comprising a number of energy-receiving modules, joint to each other in series, fixed to a common platform, and each energy-receiving module comprises a flywheel, mounted on a shaft fixed via bearing bodies to the platform, to which shaft a pulley is joined via bearings, on which pulley a ratchet pawl is mounted, engaged with a ratchet-wheel-gear, mounted on the shaft of the module, on which pulley a rope is wound, one end of which is connected to an operating float, and the other one—to a counterweight, which is specific with the fact that to the pulley a ratchet-wheel-gear is mounted, engaged with the ratchet pawl, fixed to the platform and connected with an electromagnet.

2. The wave power station, according to claim 1, is specific with the following: the operating float is connected via n-multiple polyspast to the rope, wound on the pulley.

3. The wave power station, according to claim 1, is specific with the fact that the moment for operating of the electromagnet /11/, releasing the operating float /02/, is determined by the logical control unit /09/.

4. The wave power station, according to claim 1, is specific with the fact that the operating float is situated in a protective chamber, the entrance of which is widened and facing the front of the waves.
